(19) United States
(12) Patent Application Publication
(10) Pub. No.: US 2017/0087582 A1
(43) Pub. Date: Mar. 30, 2017

(54) PAINT ROLLER RETENTION AND RELEASE ASSEMBLY

(71) Applicant: Guy Harley, Seattle, WA (US)

(72) Inventor: Guy Harley, Seattle, WA (US)

(21) Appl. No.: 14/865,717

(22) Filed: Sep. 25, 2015

(51) Int. Cl. B05C 17/02

(52) U.S. Cl. CPC B05C 17/02

(57) ABSTRACT

A paint roller retention and release assembly includes a cylinder has a first end and a second end. A perimeter wall extends between the first and second ends. A handle is attached to the first end of the cylinder such that the cylinder is rotatable with respect to the handle. A plurality of couplers is mounted in the perimeter wall. The couplers are each movable from a deployed position extending outwardly of the perimeter wall to a stored position is substantially flush with the perimeter wall. A roller brush is formed in a sleeve that is removably positioned on the cylinder. The couplers each have an outer surface that frictionally engages an interior of the roller brush when the couplers are in the deployed position.

### BACKGROUND OF THE DISCLOSURE

### Field of the Disclosure

The disclosure relates to paint roller retaining devices and more particularly pertains to a new paint roller retaining device for selectively securing a paint roller brush to a cylinder.

### SUMMARY OF THE DISCLOSURE

An embodiment of the disclosure meets the needs presented above by generally comprising a cylinder has a first end and a second end. A perimeter wall extends between the first and second ends. A handle is attached to the first end of the cylinder such that the cylinder is rotatable with respect to the handle. A plurality of couplers is mounted in the perimeter wall. The couplers are each movable from a deployed position extending outwardly of the perimeter wall to a stored position is substantially flush with the perimeter wall. A roller brush is formed in a sleeve that is removably positioned on the cylinder. The couplers each have an outer surface that frictionally engages an interior of the roller brush when the couplers are in the deployed position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a paint roller retention and release assembly according to an embodiment of the disclosure.

FIG. 2 is a cross sectional view of an embodiment of the disclosure taken along lien 2-2 of FIG. 1 showing both a deployed position and a stored position.

FIG. 3 is a cross-sectional view of an embodiment of the disclosure taken along line 3-3 of FIG. 1 showing the deployed position.

FIG. 4 is a cross-sectional view of an embodiment of the disclosure taken along line 3-3 of FIG. 1 showing the stored position.

FIG. 5 is a broken exploded view of an embodiment of the disclosure.

### DESCRIPTION OF THE PREFERRED EMBODIMENT

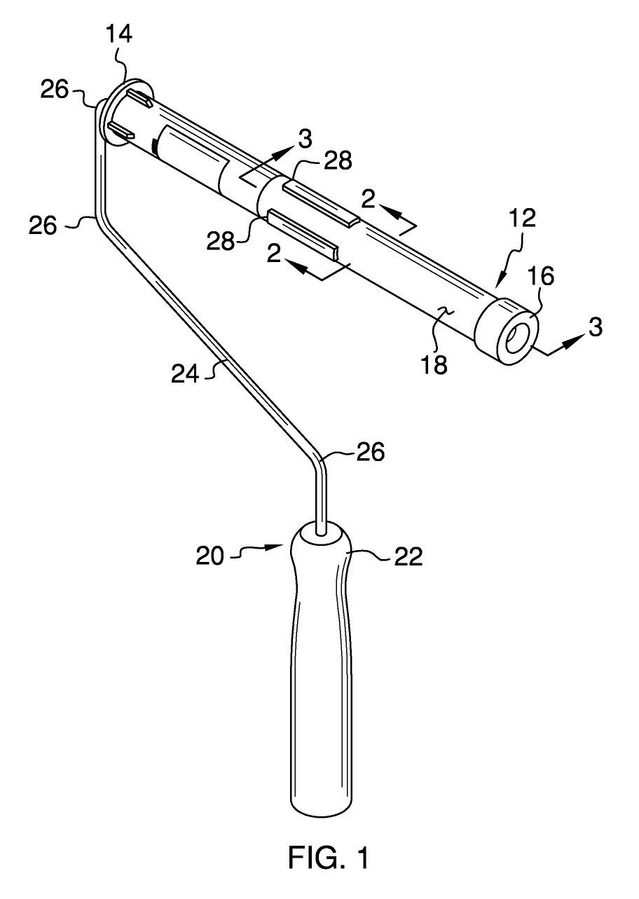

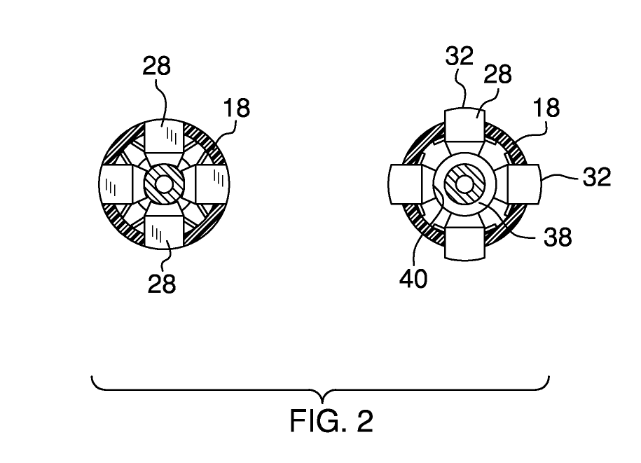

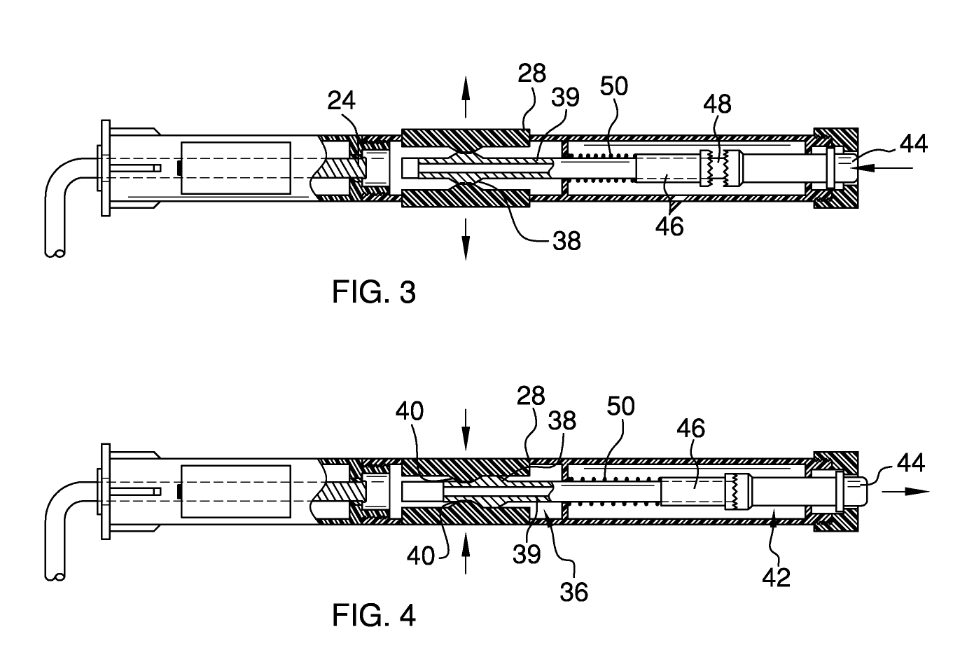

With reference now to the drawings, and in particular to FIGS. 1 through 5 thereof, a new paint roller retaining device embodying the principles and concepts of an embodiment of the disclosure and generally designated by the reference numeral 10 will be described.

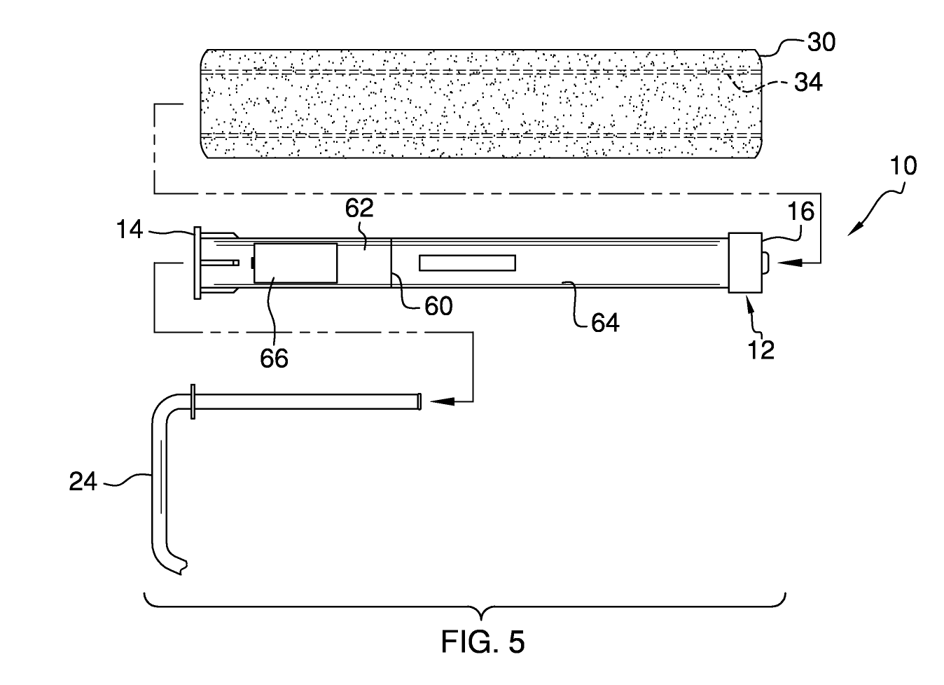

As best illustrated in FIGS. 1 through 5, the paint roller retention and release assembly 10 generally comprises a cylinder 12 that has a first end 14 and a second end 16. A perimeter wall 18 extends between the first 14 and second 16 ends. The cylinder 12 is generally hollow as can be seen in FIG. 4. A handle 20 is attached to the first end 14 of the cylinder 12 such that the cylinder 12 is rotatable with respect to the handle 20. The handle 20 includes a grip 22 and a post 24 extending therefrom having a plurality of bends 26 therein such that the grip 22 is oriented perpendicular to the cylinder 12. The post 24 may be removable from the cylinder 12 for cleaning purposes as shown in FIG. 5.

A plurality of couplers 28 is mounted in the perimeter wall 18. The couplers 28 are each movable from a deployed position extending outwardly of the perimeter wall 18 to a stored position is substantially flush with the perimeter wall 18. The couplers 28 may be positioned generally equally spaced from each of the first 14 and second 16 ends and displaced from each other radially around the cylinder 18. A roller brush 30 is formed in a sleeve and is removably positioned on the cylinder 12. The couplers 28 each have an outer surface 32 frictionally engaging an interior 34 of the roller brush 30 when the couplers 28 are in the deployed position.

An actuator 36 is mounted in the cylinder 12 and is actuated to move the couplers 28 back and forth between the deployed and stored positions. The actuator 36 generally includes a cam 38 that is mounted within the cylinder 12 and is movable along a longitudinal axis of axis of the cylinder 12 extending through the first 14 and second 16 ends. The cam 38 is positioned in an engaged condition moving the couplers 28 to the deployed position or in a disengaged condition allowing the couplers 28 to move the stored position. The couplers 28 may each include an inner face within the cylinder 12 having a detent 40 thereon for engaging the cam 38. When the cam 38 is moved to engage the couplers 28, all of the couplers 28 are simultaneously engaged. A push button mechanism 42 engages the rod 39 to move the cam 38 between the engaged and disengaged conditions. The push button mechanism 42 is conventional such as is found in retractable ball point assemblies. For example, the push button mechanism 42 may include a button 44, a follower 46 and an inner cam 48. In such a conventional structure, the button 44 is depressed to move the follower 46 against a spring 50 and the inner cam 48 rotates relative to the follower to disengage the inner cam's 48 fins, not shown, from cam slots, again not shown, in the follower 46. The spring 50 then sets the button 44 back to its original position but the length of the entire mechanism has been increased to retain the cam 38 in the engaged condition. The button 44 is pressed again to again rotate the inner cam 48 relative to the follower 46 to allow the inner cam 48 to slide into the follower 46. As the button 44 is released the spring 50 moves the follower 46 along with the cam 38 to towards the second end 16 and into the disengaged condition. Thus, the push button mechanism 42 is depressed alternatingly to move the cam 38 between the engaged and disengaged conditions. The above is just one example of a plurality of different push button mechanisms, all of which would work with the rod 39 as indicated above.

As can be seen in the Figures, the cylinder 12 may include a break 60 therein to define a pair of sections 62, 64 removably coupled together and which may further include an access door 66. The pair of sections 62, 64 are threadably coupled together though other means of releasably attachment may be utilized. The access door 66 and ability to separate the sections 62, 64 allows the cylinder 12 to be thoroughly cleaned on an interior thereof to ensure proper functioning of the assembly 10.

In use, the user would actuate the actuator 36 to move the couplers 28 to the stored position so that the roller brush 30 might be easily slid onto the cylinder 12. The actuator 36 would then be actuated again to move the couplers 28 to the deployed position frictionally engaging the roller brush 30 such that it is retained on the cylinder 12. When the user was finished painting, the couplers 28 would be moved to their stored positions once again to facilitate removal of the roller brush 30 from the cylinder 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A paint roller retaining assembly comprising:
a cylinder having a first end and a second end, a perimeter wall extending between said first and second ends;
a handle being attached to said first end of said cylinder such that said cylinder is rotatable with respect to said handle;
a plurality of couplers being mounted in said perimeter wall such that said perimeter wall is substantially continuous around said couplers and between said first end and said second end, said couplers each being movable from a deployed position extending outwardly of said perimeter wall to a stored position being substantially flush with said perimeter wall; and
a roller brush being formed in a sleeve and being removably positioned on said cylinder, said couplers each having an outer surface frictionally engaging an interior of said roller brush when said couplers are in said deployed position.

2. The paint roller retaining assembly of claim 1,
further including an actuator being mounted in said cylinder and being actuated to move said couplers back and forth between said deployed and stored positions.

3. A paint roller retaining assembly comprising:
a cylinder having a first end and a second end, a perimeter wall extending between said first and second ends;
a handle being attached to said first end of said cylinder such that said cylinder is rotatable with respect to said handle;
a plurality of couplers being mounted in said perimeter wall such that said perimeter wall is substantially continuous around said couplers and between said first end and said second end, said couplers each being movable from a deployed position extending outwardly of said perimeter wall to a stored position being substantially flush with said perimeter wall;
a roller brush being formed in a sleeve and being removably positioned on said cylinder, said couplers each having an outer surface frictionally engaging an interior of said roller brush when said couplers are in said deployed position;
an actuator being mounted in said cylinder and being actuated to move said couplers back and forth between said deployed and stored positions, said actuator including:
a cam being mounted on a rod within said cylinder and being movable along a longitudinal axis of said cylinder extending through said first and second ends, said cam being positioned in an engaged condition moving said couplers to said deployed position or in a disengaged condition allowing said couplers to move said stored position; and
a push button mechanism engaging said rod, said push button mechanism extending outwardly from said second end of said cylinder, said push button mechanism being depressed alternatingly to move said cam between said engaged and disengaged positions.
